(19) United States
(12) Patent Application Publication
(10) Pub. No.: US 2021/0042275 A1
(43) Pub. Date: Feb. 11, 2021

(54) DATA BLOCKING IN A DATABASE SYSTEM

(71) Applicant: International Business Machines Corporation, Armonk, NY (US)

(72) Inventor: Mohammad Khatibi, Richmond Hill (CA)

(21) Appl. No.: 16/799,351

(22) Filed: Feb. 24, 2020

(30) Foreign Application Priority Data
Aug. 5, 2019 (EP) 19189987.1

(51) Int. Cl. G06F 16/21

(52) U.S. Cl. CPC G06F 16/211

(57) ABSTRACT

A method is disclosed for storing a dataset in a database system. The dataset comprises records having values of multiple attributes. The method comprises determining an ordered set of attributes of the multiple attributes. For each distinct value of the first ordered attribute of the set a first level data block may be created. The first level data block is configured to comprise a maximum number of records. Data records of the dataset having a distinct value of the first ordered attribute may be stored in the respective created multi-level data blocks.

### BACKGROUND

The present invention relates to the field of digital computer systems, and more specifically, to a method for storing a dataset in a database system.

Entity Resolution (ER) is the process for identifying the same real-world data across different sources of information, by cross-comparing data from all sources of information to conclude entity profiles. However, this process may be intensive and time consuming.

### SUMMARY

Various embodiments provide a method for storing a dataset in a database system, computer system, and computer program product as described by the subject matter of the independent claims. Advantageous embodiments are described in the dependent claims. Embodiments of the present invention can be freely combined with each other if they are not mutually exclusive.

In one aspect, the invention relates to a method for storing a dataset in a database system, the dataset comprising records having values of multiple attributes. The method comprises:
a) determining an ordered set of attributes of the multiple attributes;
b) for each distinct value of the first ordered attribute of the set creating a first level data block; the first level data block being configured to comprise a maximum number of records;
c) storing data records of the dataset having a distinct value of the first ordered attribute in the respective created first level data block;
d) in case a data block has the maximum number of records,
   determining a level of the data block;
   determining a subset of attributes of the set, the subset of attributes comprising attributes having an order starting from the first order to a subsequent level of the determined level;
   for each distinct group of values of the subset of attributes creating a next level data block, the next level is subsequent to the determined level, the next level data block being configured to comprise the maximum number of records;
   storing data records of the dataset having a distinct group of values of the subset of attributes in the respective created next level data block;
e) repeating step d) for each created data block, resulting in a group of blocks associated with the first ordered attribute.

In another aspect, the invention relates to a computer system for storing a dataset in a database system, the dataset comprising records having values of multiple attributes. The computer system is configured for:
a) determining an ordered set of attributes of the multiple attributes;
b) for each distinct value of the first ordered attribute of the set creating a first level data block; the first level data block being configured to comprise a maximum number of records;
c) storing data records of the dataset having a distinct value of the first ordered attribute in the respective created first level data block;
d) in case a data block has the maximum number of records,
   determining a level of the data block;
   determining a subset of attributes of the set, the subset of attributes comprising attributes having an order starting from the first order to a subsequent level of the determined level;
   for each distinct group of values of the subset of attributes creating a next level data block, the next level is subsequent to the determined level, the next level data block being configured to comprise the maximum number of records;
   storing data records of the dataset having a distinct group of values of the subset of attributes in the respective created next level data block;
e) repeating step d) for each created data block, resulting in a group of blocks associated with the first ordered attribute.

In another aspect, the invention relates to a computer program product comprising a computer-readable storage medium having computer-readable program code embodied therewith, the computer-readable program code configured to implement all of steps of the method according to preceding embodiments.

The present subject matter may increase the storage efficiency of data by blocking them based on their content. This may, for example, enable to store the data blocks in a distributed database. The present subject matter may enable to obtain consistent storage of data e.g. if the present method is executed on different database systems, the blocking may be similar in the database systems.

Another advantage may be that the present subject matter may easily scale with increasing data. For example, the blocking may result in blocks of records that may be stored separately e.g. instead of storing all the records in one storage or one disk, by blocking them in accordance with the present subject matter some blocks may be stored separately from other blocks. This may enable a flexible storage of the data by distributing them over a distributed storage system.

Another advantage may be that the present subject matter may enable an efficient access to data stored in a database system. For example, the blocking in accordance with the present subject matter may make processing more efficient as the blocks are defined based on content of their data. In addition, an entire block as herein defined and created can be accessed at once instead of reading or writing records individually.

Another advantage may be the handling of the large-sized blocks is addressed by the present subject matter by controlling the maximum size of each block. Having small sized blocks for each block type may facilitate the processing of the records for the following reasons. For example, when a block becomes a common block for a large number of records (like a blocking on a most-used first name and last name in a dataset, e.g. 5000 records for ‘John Smith’ variation in a dataset) it causes entity resolution to go after excessive number of comparisons as a result of large number of candidates in the same block. This essentially makes such impacted frequent blocks unusable/inefficient, while such block type (first name+last name) may still be useful and required for non-frequent blocks.

Assuming an upper limit of the block size is reasonably chosen, the advantage of the present subset matter may be that it dynamically handles when a large block is faced. Entity Resolution can work reasonably as it wouldn't need to process a large candidate set, but instead it may pick a reasonable number of candidates from level 1 to its applicable block level per block type.

### BRIEF DESCRIPTION OF THE DRAWINGS

In the following embodiments of the invention are explained in greater detail, by way of example only, making reference to the drawings in which:

FIG. 1 depicts a block diagram representation of an exemplary master data management system.

FIG. 2 is a flowchart of a method for storing a dataset in a database system in accordance with an example of the present disclosure.

FIG. 3 is a flowchart of a method for storing a dataset in a database system.

FIG. 4 is a flowchart of a method for matching a data record R1 with content of a database system.

FIG. 5A is a table listing example data blocks that are created in accordance with an example of the present disclosure.

FIG. 5B is a table listing data blocks that are identified for executing an example request in accordance with an example of the present disclosure.

FIG. 5C is a table listing data blocks that are identified for executing an example request in accordance with an example of the present disclosure.

FIG. 5D is a table listing data blocks that are identified for executing an example request in accordance with an example of the present disclosure.

FIG. 6 represents a computerized system, suited for implementing one or more method steps as involved in the present disclosure.

### DETAILED DESCRIPTION

The descriptions of the various embodiments of the present invention are being presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A dataset is a collection of one or more data records. For example, the dataset may be provided in the form of a collection of related records contained in a file e.g. the dataset may be a file containing records of all students in class. The dataset may, for example, be a table of a database or a file of a Hadoop file system, etc. In another example, the dataset may comprise a document such as a HTML page or other document types. The document may, for example, comprise data of a patient.

A data record or record is a collection of related data items such as a name, date of birth and class of a particular user. A record represents an entity, wherein an entity refers to a user, object, or concept about which information is stored in the record. The terms “data record” and “record” are interchangeably used. The data records may be stored in a graph database as entities with relationships, where each record may be assigned to a node or vertex of the graph with properties being attribute values such as name, date of birth etc. The data records may, in another example, be records of a relational database.

The dataset may for example be received from one or more sources of data before being processed by the present method. The processed records may, for example, be stored in a central repository. The central repository may be a data store, storage, or database that stores data received from multiple client systems. Additionally, or alternatively, the dataset may comprise existing records of the database system that are identified or selected in order to be processed by the present method. For example, a user selection of records of the dataset may be received. The records of the dataset may for example be pre-processed before being processed by the present method. The pre-processing may for example comprise transforming the format of the attribute values of the records of the dataset. For example, attribute values may be uppercased, their noise characters (such as - . / characters) may be removed. Anonymous attribute values (like a city=nowhere or first name=Test) may be removed and word mapping of attribute values may be performed to map a given attribute value to a corresponding predefined value (e.g. St. becomes Street after mapping St. to Street).

A data block is one or more units of recording on disk. A block size may be the physical block size written on the disk for records.

The group of blocks may have a category. The category may be defined or named by the first ordered attribute. The group may comprise at least Blocks B1, where Blocks B1 are created (e.g., in step b)) for the first ordered attribute. Blocks B1 are associated with the first ordered attribute. In this case, the first ordered attribute may be referred to as block type for blocks B1. In addition, the group may comprise blocks Bn (n>=2) that are created (e.g., in step d)) for a subset of two or more attributes, wherein the subset of attributes comprises the first ordered attribute and one or more other attributes of the set of attributes. Blocks Bn are associated with the subset of n attributes. Blocks B1 may be instances or block values of the block type defined by the first ordered attribute. Blocks Bn may be instances or block values of the block type defined by the subset of attributes e.g. the block type may be defined or named as “first ordered attribute+attribute_1 . . . attribute_n−1”.

The level of a data block may be represented by a value indicative of the level. For example, the first level may be represented by value 1, the second level may be represented by value 2, and the n^{th} level may be represented by value n. The level of a data block may be the value that represents that level e.g. the level of the first level data block is 1. Similarly, the order of an attribute of the set of attributes may be represented by a value indicative of the order. For example, the first order may be represented by value 1, the second order may be represented by value 2, and the n^{th} order may be represented by value n. The order of an attribute may be the value that represents that order e.g. the order of the first ordered attribute is 1. For example, the feature “an order starting from the first order to a subsequent level of the determined level” comprises or means that the order is between 1 and i+1, where i is the determined level e.g. if the determined level is the second level i=2, then the order is between 1 and 3.

According to one embodiment, the method further comprises repeating steps a) to e) for one more different further ordered sets of attributes of the multiple attributes, resulting in different groups of blocks associated with the first ordered attribute of the respective ordered set of attributes. Each group of the different groups may be labeled or categorized by the first ordered attribute that has been used to create the group. For example, a group may be labeled as name group if the first ordered attribute is a name attribute and another group may be labeled as address group if the first ordered attribute is an address attribute etc. This embodiment may further increase the storage efficiency as further groups may be defined using further information on the content of data to be stored.

According to one embodiment, the different ordered sets of attributes are not overlapping. This may enable to increase the diversity of the blocks and thus further data may be stored.

According to one embodiment, the method further comprises: receiving a record having at least a non-empty value of the first ordered attribute of the set of attributes; determining from the group of blocks all applicable full blocks that have the maximum number of records and an additional applicable block that has less than the maximum number of records and that has a level that is equal or subsequent to the highest level of the determined full blocks; comparing the received record with each record of the determined blocks. For example, if a block value or instance at any level (let's assume Level 1) is over populated, then the record may not be assigned to the block and instead the block at the next level (or at a same level) may be examined. This may be done till one get to a new block or a less-populated block. Then the record may be assigned to that block and other blocks at other levels may be ignored.

This embodiment may enable an effective ER for a large volume as it may minimize the number of cross comparisons. The data blocking groups similar data into same blocks and may thus help to cut down the required comparisons to conclude entity profiles. The ER may be effective because the comparisons involve small sized data blocks.

According to one embodiment, the distinct group of values comprises an empty value of an attribute that is different from the first ordered attribute. An attribute that has an empty value refers to an attribute that does not have a value.

According to one embodiment, the method further comprises receiving a record having at least one non-empty value of an attribute of the multiple attributes; identifying one or more groups of blocks that are associated with the at least one non-empty attribute; for each of group of the one or more groups: determining from the group of blocks all applicable full blocks that have the maximum number of records and an additional applicable block that has less than the maximum number of records and that has a level that is equal or subsequent to the highest level of the full blocks; comparing the received record with each record of the determined blocks. This embodiment may enable an effective ER for a large volume as it may minimize the number of cross comparisons. The data blocking groups similar data into same blocks and thus may help to cut down the required comparisons to conclude entity profiles. The ER may be effective because the comparisons involve small sized data blocks.

According to one embodiment, the additional block is further associated with an attribute of the subset of attributes that has an empty value.

According to one embodiment, comparing the received record comprises loading into a memory the identified groups of blocks for performing the comparison in the memory. Since the size of the blocks is controllable by the present subject matter, the loading to the memory may be controlled accordingly. Using the memory may speed up the processing of the blocks.

According to one embodiment, the maximum number of records is determined based on the size of the memory.

According to one embodiment, the method further comprises deduplication of the data based on the comparison result.

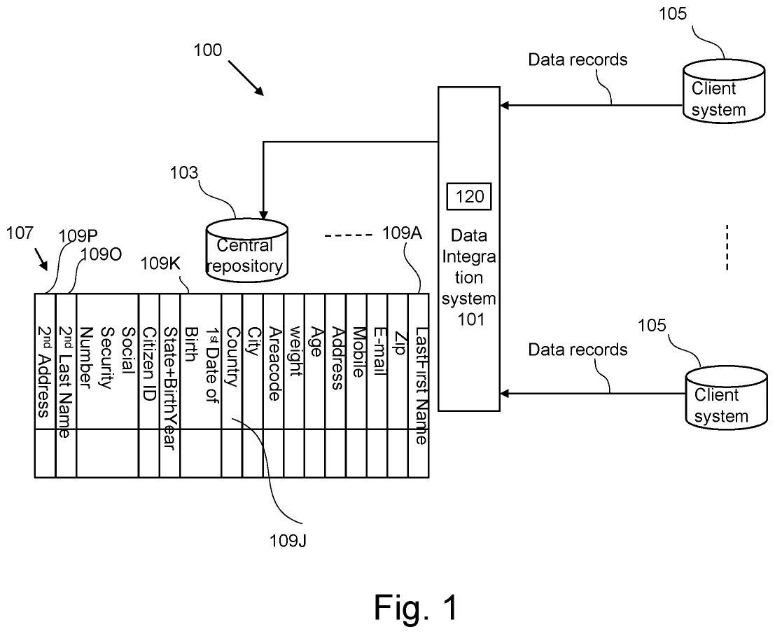

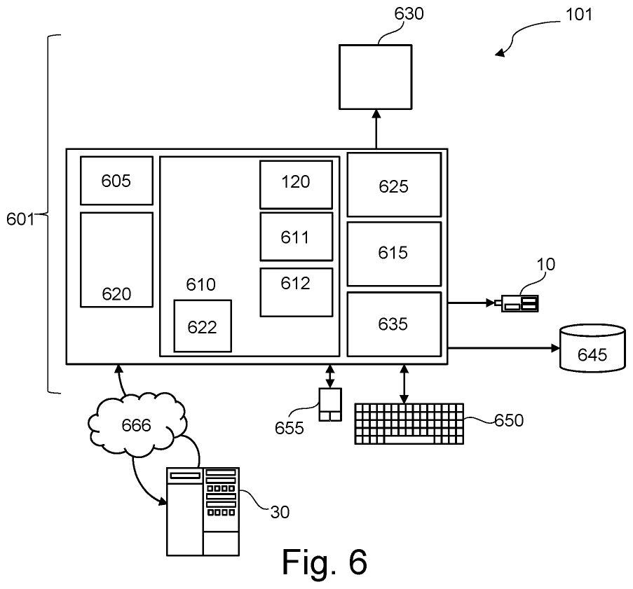

FIG. 1 depicts an exemplary computer system 100. The computer system 100 may, for example, be configured to perform master data management and/or data warehousing. The computer system 100 comprises a data integration system 101 and one or more client systems or data sources 105. The client system 105 may comprise a computer system (e.g. as described with reference to FIG. 6). The data integration system 101 may control access (read and write accesses etc.) to a central repository 103. The storage system may comprise the central repository 103.

Data integration system 101 may process records received from client systems 105 and store the data records into central repository 103 in accordance with the present subject matter. The client systems 105 may communicate with the data integration system 101 via a network connection which comprises, for example, a wireless local area network (WLAN) connection, WAN (Wide Area Network) connection LAN (Local Area Network) connection or a combination thereof

The data records stored in the central repository 103 may have a predefined data structure 107 such as a data table with multiple columns and rows. The predefined data structure may comprise multiple attributes 109A-P (e.g. each attribute representing a column of the data table 107). In another example, the data records may be stored in a graph database as entities with relationships. The predefined data structure may comprise a graph structure where each record may be assigned to a node of the graph. Although the present example is described in terms of few attributes, more or less attributes may be used. The multiple attributes 109A-P may, for example, be dynamically updated or determined while receiving data records e.g. if a received data record has a new attribute that is not part of the multiple attributes 109A-P, that new attribute may be added to the multiple attributes 109A-P. In another example, the multiple attributes 109A-P may be determined based on historical data indicating all attributes that are used by client systems 105.

For example, the client systems 105 may be configured to provide or create data records which may or may not have the same data structure 107. The attributes of each record received from the client systems 105 may comprise all the attributes 109A-P or only part of the attributes 109A-P. Comprising only part of the attributes means that the received record has non-empty values for that part of attributes and has empty values for the other part of the attributes of the multiple attributes 109A-P. For example, a client system 105 may be configured to provide records in XML or JSON format or other formats that enable to associate attributes and corresponding attribute values, wherein at least part of the attributes 109A-P are associated in the XML with respective values.

Each client system 105 may be configured to send the created data records to the data integration system 101 in order to be stored on the central repository 103 after being processed in accordance with an example method of the present disclosure. Before being processed, the received record may be transformed e.g. by the data integration system 101, into a format of the data structure 107.

In one example, data integration system 101 may import data records from a client system 105 using one or more Extract-Transform-Load (ETL) batch processes or via HyperText Transport Protocol (“HTTP”) communication or via other types of data exchange. The data integration system 101 and/or client systems 105 may be associated with, for example, Personal Computers (PC), servers, and/or mobile devices.

Each data record received from client systems 105 by the data integration system 101 may or may not have all values of the multiple attributes 109A-P e.g. a data record may have values of a subset of attributes of the set of attributes and may have empty values for the remaining attributes. In other words, the records provided by the client systems 105 may have different completeness. The completeness is the ratio of number of attributes of a data record comprising data values to a total number of attributes in the multiple attributes 109A-P.

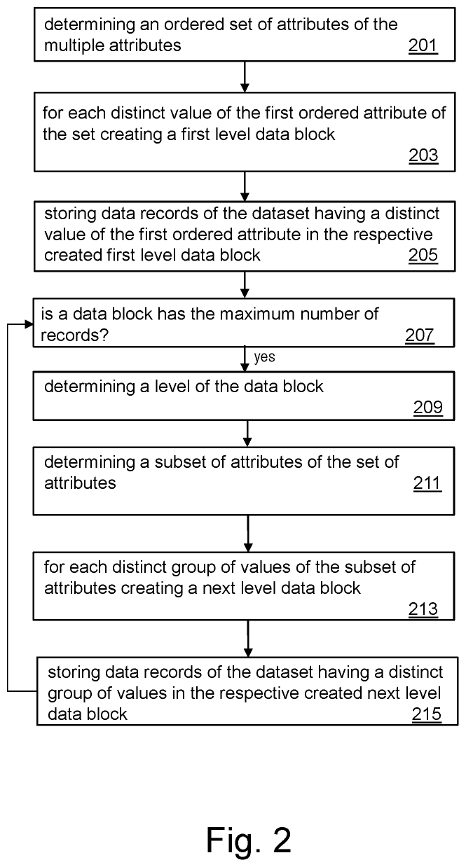

The data integration system 101 may be configured to process the received records using one or more algorithms such as an algorithm 120 implementing at least part of the present method. For example, the data integration system 101 may process the data records received from the client systems 105 using the algorithm 120 in order to perform at least part of the present subject matter e.g. as described with reference to FIG. 2.

FIG. 2 is a flowchart of a method for storing a dataset in a database system such as system 100. For simplification purpose, the method of FIG. 2 will be described with reference to FIG. 1 but it is not limited to.

The dataset may comprise data records. The dataset may for example be received from one or more of the client systems 105 at the data integration system 101. In another example, the dataset may be an existing dataset, of one or more databases such as the central repository that is to be rearranged or restored in accordance with the present subject matter.

The data records of the dataset may, for example, have at least part of the attributes 109A-P. The data records of the dataset may or may not have the data structure 107. In case the received data records have a structure different from the predefined structure 107, a transformation process may be executed in order to transform the structure of the records of the dataset to the data structure 107.

In step 201, an ordered set of attributes of the multiple attributes 109A-P may be determined. In one example, the set of attributes may comprise all attributes of the multiple attributes 109A-P. This may enable to store more data as the blocking enabled by the present method may be more flexible when using more attributes. In another example, the set of attributes may first be selected from the multiple attributes 109A-P e.g. the set of attributes comprises only part of the multiple attributes 109A-P. This may enable to speed up the blocking in accordance with the present subject matter. This may particularly be advantageous as different sets of attributes may be used with different orders for performing the blocking in accordance with the present method.

The set of attributes may be ordered so as to obtain the ordered set of attributes. The set of attributes may for example be ordered by arranging them in a sequence ordered by a predefined criterion. In one example, the criterion may be a user defined criterion e.g. a user may be prompted to provide the order set of attributes by for example providing the multiple attributes and requesting that they are to be ordered. The user may provide, in response to the prompting, the ordered set of attributes. This may enable an efficient storage method, because the order given is accurate and reliable. In another example, the criterion may require that the attribute that uniquely identify a record is first ordered and then followed by any other attributes of the multiple attributes to for the ordered set of attributes. In a further example the set of attributes may be randomly ordered. This may enable a systematic method.

The term “user” refers to an entity e.g., an individual, a computer, or an application executing on a computer. The user may, for example, represent a group of users.

For simplification of the description, the ordered set of attributes may be described as comprising three attributes, namely attributes 109A-B, LastNameFirst Name, followed by Email address and by Mobile number. The ordered set of attributes may be as follows LastNameFirst Name->Email->Mobile, wherein LastNameFirst Name is the first ordered attribute having the first order ORD1, Email is the second ordered attribute having the second order ORD2 and Mobile is the third (last) ordered attribute having the third order ORD3.

For each distinct value of the first ordered attribute of the set of attributes, a first level data block (L1 block) may be created in step 203. The first level data block is configured to comprise a maximum number of records e.g. 1000. The distinct values may for example be predefined e.g. a metadata describes the different distinct values of each of the attributes 109A-P may be used to determine the distinct values of the first ordered attribute. In another example, the distinct values may be determined from the dataset and/or from previously stored data e.g. in the central repository 103. The created blocks for the first ordered attribute, have a first level L1. There is a correspondence (level or order value i) between a level of a data block Li and an order of attribute ORDi for which the data block has been created e.g. L1 corresponds to ORD1 (level 1 and order 1), L2 corresponds to ORD2 (level 2 and order 2), L3 corresponds to ORD3 (level 3 and order 3) . . . and Ln corresponds to ORDn (level n and order n).

Following the above example, if the first ordered attribute LastNameFirstName has distinct values such as Smith John and Westbay Arde, two first level data blocks (e.g. two L1 blocks named L1SmithJohn and L1WestbayArde) may be created in step 203 respectively. The two L1 blocks L1SmithJohn and L1WestbayArde are instances of the L1 block of type LastNameFirstName.

Data records of the dataset having a distinct value of the first ordered attribute may be stored in step 205 in the respective created first level data block. For example, data records of the dataset that have a (non-empty) distinct value of the first ordered attribute may be identified and may be stored in the respective created L1 block. Following the above example, all records of the dataset having distinct values Smith John and Westbay Arde may be identified. The records having the value Smith John may be stored in the L1 block L1SmithJohn and the records having the value Westbay Arde may be stored in the L1 block L1WestbayArde.

It may be determined in inquiry step 207, if a data block of the created data blocks has the maximum number of records e.g. if the data block has reached the maximum size. Assuming for exemplification purpose that the data block L1SmithJohn has the maximum number of records.

If it is determined that a data block of the created data blocks has the maximum number of records, a level of the data block may be determined in step 209. Following the above example, it may be determined in step 207 that the data block L1SmithJohn has the maximum number of records. This data block L1SmithJohn has a level L or level 1.

Using that determined level a subset of attributes of the set of attributes may be determined in step 211. The subset of attributes comprises attributes having an order starting from the first order ORD1=1 to a subsequent level L2=2 of the determined level L1. Following the above example of set of 3 attributes, the subset of attributes may comprise LastNameFirstName and Email because LastNameFirstName has order ORD1 and Email has an order which corresponds to the subsequent level L2 which is ORD2.

For each distinct group of values of the subset of attributes a next level data block may be created in step 213. The distinct group of values of the subset of attributes may for example be determined using records of the dataset and/or other records stored in the database system. The next level is subsequent to the determined level. If for example, the determined level is L1, the next level is L2. The next level data block is configured to comprise the maximum number of records. Following the above example, the following groups of values are example distinct values of the subset of attributes LastNameFirstName and Email: group1: Smith+John+smith@test.com, group2 Smith+John+john@smith.com and group3 Smith+John+. The third group group3 of distinct values comprises an empty value of the E-mail attribute. In this case, three L2 blocks may be created L2Smith+John+smith@test.com, L2Smith+John+john@smith.com and L2Smith+John+. The blocks L2Smith+John+smith@test corn, L2Smith+John+john@smith.com and L2Smith+John+are instances of the L1 block of type LastNameFirstNameEmail.

In step 215, data records of the dataset having a distinct group of values of the subset of attributes may be stored in the respective created next level data block. Following the above example, all records of the dataset having the group of distinct values group1, group2 and group 3 may be identified. The records having the group of values group1 may be stored in the L2 block L2Smith+John+smith@test.com, the records having the group of values group2 may be stored in the L2 block L2Smith+John+john@smith.com and the records having the group of values group3 may be stored in the L2 block L2Smith+John+. Assuming for example that only L2Smith+John+john@smith.com has reached the maximum number of records.

Steps 207 to 215 may iteratively be performed. The steps 207-215 may be repeated for further blocks which are newly created and which are previously checked but were not at their maximum size. The repetition of steps 207-215 for a previously processed block may, for example, only be performed if there is a change that occurred in that block from the last execution of steps 207-215. Following the above example, steps 207 to 215 may be repeated for previously checked L1 block L1 WestbayArde and newly created L2 blocks. Steps 207 to 215 may for example be repeated on a periodic basis e.g. every day or every hour. This may enable to automatically implement the present method. In another example, as soon as a new block is created and/or as soon as one or more new records are stored in one of the previously checked blocks, steps 207-215 may be repeated. By automatically reacting to changes, the process of blocking may be improved and speed up. In another example, Steps 207-215 may continuously be repeated. This may for example, be advantageous in case of a system that continuously receives data. In another example, steps 207-215 may be repeated in a predefined time period e.g. the predefined time period may one predefined month or week. This may particularly be advantageous in case a user may decide to organize or store his/her data in the database system at once.

Following the above example, in a first iteration of steps 207-215, step 207 may identify that block L2Smith+John+john@smith.com has the maximum number of records. The level of the block may be determined as being L2 or level 2, and the subset of attributes of step 211 may comprise attributes having order 1 to level 3, or having ORD1 to ORD3. This may result in the subset of attributes comprising LastNameFirstName, Email and Mobile because LastNameFirstName has order ORD1, Email has order ORD2 and Mobile has order ORD3 which corresponds to the subsequent level L3. For each distinct group of values of the subset of attributes a next level data block may be created in step 213. The next level 3 is subsequent to the determined level 2. The next level data block is configured to comprise the maximum number of records. Following the above example, the following group of values are an example distinct values of the subset of attributes LastNameFirstName, Email and Mobile: Smith+John+smith@test.com+8888888. In this case, the following L3 block may be created: L3Smith+John+smith@test.com+8888888. And data records of the dataset having the distinct group of values Smith+John+smith@test.com+8888888 may be stored in the block L3Smith+John+smith@test.corn+8888888. The block L3Smith+John+smith@test.com+8888888 is an instance of the L3 block of type LastNameFirstNameEmailMobile.

Repeating the steps 207 to 215, would result in a group GRP1 of data blocks that have all been created starting from the first ordered attribute (e.g. as seed). This group of blocks may, for example, be said or labeled as belonging to the category of the first ordered attribute e.g. Name category because the first ordered attribute is a name. The group GRP1 may be associated with a category metadata comprising a string (“LastNameFirstName”) descriptive of the first ordered attribute that is used as seed to create blocks of GRP1. The string may be defined using a group category name building method e.g. that concatenates last name and first name. Each block of the group may be associated with an instance metadata. The instance metadata indicate the values of the corresponding attributes with references to the records of the data block. For example, the instance metadata of data block L2Smith+John+john@smith.com may comprise a string “Smith+John+john@smith.com” that is built from the values of the attributes LastNameFirstName+Email using an instance name building method. The category metadata may further comprise instance metadata of each data block of the group GRP1.

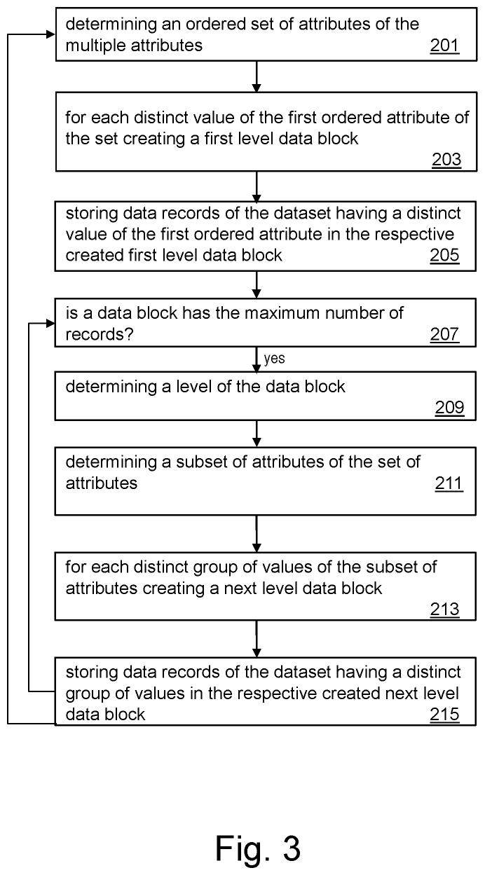

FIG. 3 is a flowchart of a method for storing a dataset in a database system such as system 100. FIG. 3 comprises the method of FIG. 2. In addition, the steps 201-215 are repeated in FIG. 3 for another ordered set of attributes. This may particularly be advantageous if further categories or groups of blocks are to be created. For example, another ordered set of attributes that has the first ordered attribute being an address may be used as the first ordered attribute of the other ordered set of attributes. Thus, by repeating the method of FIG. 2 using another starting point or seed (other first ordered attribute), another category of blocks may be created. For example, blocks of Address category may be created. The method of FIG. 3 may for example result in groups GRP1, GRP2 . . . GRPn of blocks of different n categories. The blocks of the same level of each group of the groups may be referred to as instances of a same block type e.g. L1 blocks of GRP1 are of same block type LastNameFirsName.

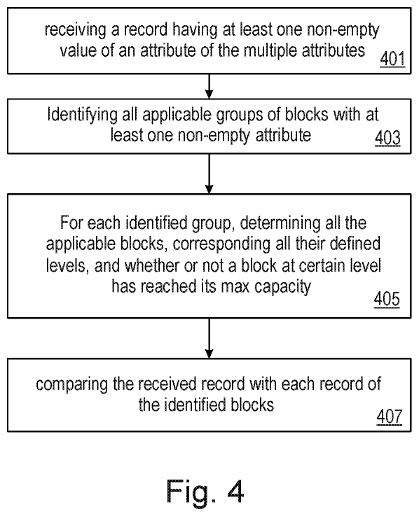

FIG. 2 and FIG. 3 may be advantageous as they store data in efficient way. The storage is organized based on the content of data. This may enable a flexible storage of the data blocks. For example, data blocks of each category may be stored separately from the data blocks of a different category. Another advantage may be that the search of duplicate records may be faster and easier using the blocking of FIGS. 2 and 3 as described with reference to FIG. 4.

FIG. 4 is a flowchart of a method for matching a data record R1 with content of a database system.

The record R1 may for example be received in step 401. The record R1 may have at least one non-empty value of an attribute of the multiple attributes. Following the above example, the record R1 may have at least a value of the attribute LastNameFirsName in order to search blocks of name category.

One or more applicable groups of blocks that are associated with the at least one non-empty attribute may be identified, in step 403, among the groups GRP1-GRPn. In other words, for each attribute of the received record it may be determined if that attribute was used in FIG. 2 or FIG. 3 as a seed for the creation of blocks of a group. Following the above example, step 403 may identify group GRP1 because it is the group category of the attribute of the record R1 e.g. the attribute of record R1 was used as the seed for the creation of the blocks of group GRP1. Step 403, may be performed by creating for each non-empty attribute of R1 a string using the group category name building method. That created string(s) may be compared with the category metadata in order to find which applicable groups for the received R1.

For each group of the one or more groups, it may be determined in step 405, all applicable blocks that have the maximum number of records and an additional block that has less than the maximum number of records and that has a level that is equal or subsequent to the highest level of the identified blocks of step 405. This may for example be performed by using the category metadata of the identified group. In other words, for each identified group of the one or more groups, all the applicable blocks, corresponding all their defined levels may be determined, and it may be determined whether or not a block at certain level has reached its maximum capacity. Assuming for example that blocks L1SmithJohn, L2Smith+John+smith@test.com and L2Smith+John+john@smith.com of the group GRP1 are identified in step 405 as having the maximum number of records. The highest level of the identified blocks in this case is L2. If the third L2 block L2Smith+John+is also full, the additional block may be a block of level 3, that is for example named as L3Smith+John+john@smith.com88888. If the third L2 block L2Smith+John− is not full, the additional block may be L2Smith+John+.

In step 407, the received record R1 may be compared with each record of the identified blocks. This may enable an entity resolution using only relevant blocks. This may save processing time and resources that would otherwise be required for processing any created block.

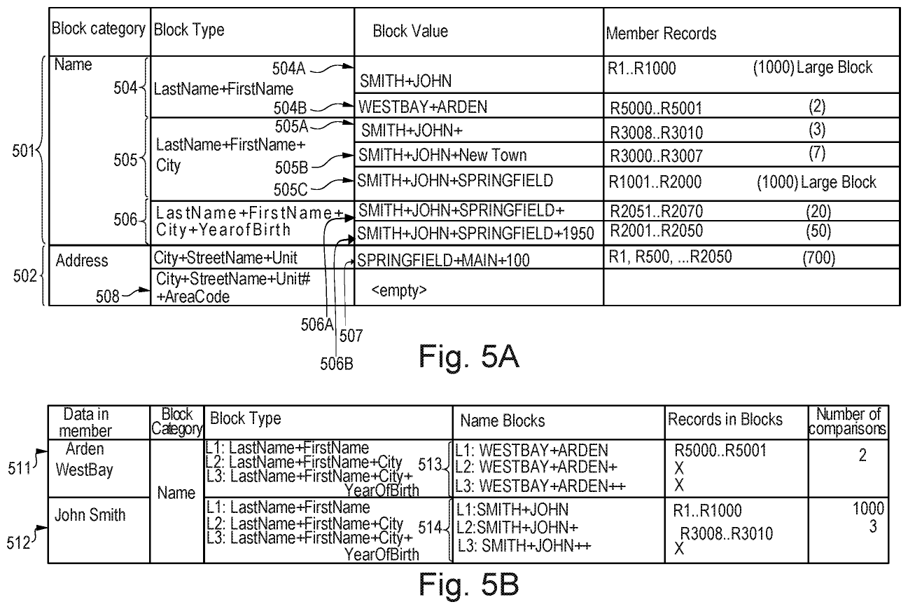

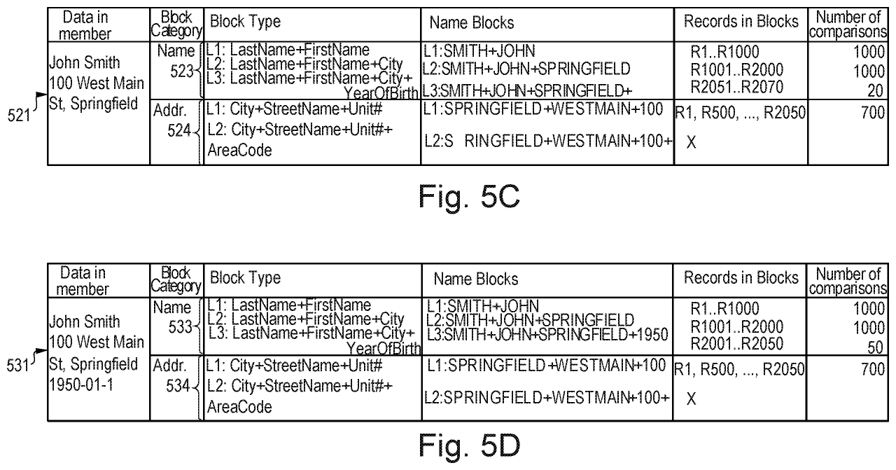

FIGS. 5A-D illustrate examples for processing a received record using data blocks that are created in accordance with the present subject matter.

FIG. 5 shows two groups of blocks 501 and 502. The group of blocks 501 has Name category and the group of blocks 502 has Address category.

The group 501 comprises L1, L2 and L3 blocks (three level blocks) 504-506. The L1 blocks 504 are of type LastName+FirstName and comprise instances 504A-B. L2 blocks 505A-C are instances of the block type LastName+FirstName+City and the L3 blocks 506A-B are instances of the block type LastName+FirstName+City+YearOfBirth.

The group 502 comprises L1 and L2 blocks (two level blocks) 507-508. L1 block 507 is an instance of the block type City+StreetName+Unit#. The group 502 has no instances of the L2 block 508 of type City+StreetName+Unit#+AreaCode.

Thus, a new incoming record can lead the entity resolution to cross compare the incoming record with the different existing records in the system, based on the applicable blocks 504-508 and levels to the new records.

For example, when the new record includes a Name only, the table of FIG. 5B shows the blocks that have been identified in order to perform the entity resolution for the new record. FIG. 5B shows an example of two received records 511 and 512 each having a value of the attribute LastNameFirstName. The method may then search blocks in the group that has been created using the attribute LastNameFirstName as seed or as first ordered attribute. FIG. 5B shows examples of block instances 513 and 514 in different levels that are candidates to be used for comparison with the received records 511 and 512 respectively.

For example, FIG. 5B shows that for a less-frequent name scenario such as Arden Westbay of the record 511, the method (e.g. of FIG. 4) finds the L1 block 504B not oversized and so it only considers the records in that block 504B for entity resolution. The method cross compares the incoming record 511 with a total of 2 candidates. However, for a high-frequent name scenario such as John Smith, the method finds L1 block 504A has reached its capacity and so it continues with L2 block 505A that has not reached its capacity, so the method cross compares the incoming record 512 with a total of 1000+3=1003 candidates.

In another example of FIG. 5C, when the new record 521 includes a value of two attributes LastNameFirstName and Address, the method has a possibility for searching for blocks in two different group categories of blocks 523 and 524. The first group category 523 is the Name category that has been created using the attribute LastNameFirstName as seed or as first ordered attribute. The second group category 524 is the Address category that has been created using the attribute Address as seed or as first ordered attribute.

For the attribute LastNameFirstName, the method finds out that L1 and L2 blocks 504A and 505C have reached their capacity and L3 block 506A has not. The method thus finds 1000+1000+20=2020 candidate records from blocks of the first group category.

For the attribute Address, the method finds 700 candidates for L1 block 507. So the total number of candidates may be based on the unique list of candidates across these two sets of 2020 and 700 candidates. The received record 521 may be compared with each of the 2720 records.

In another example of FIG. 5D, when the new record 531 includes a value of three attributes LastNameFirstName, Address and date of birth, the method has a possibility for searching for blocks in two different group categories of blocks 533 and 534. The first group category 533 is the Name category that has been created using the attribute LastNameFirstName as seed or as first ordered attribute. The second group category 534 is the Address category that has been created using the attribute Address as seed or as first ordered attribute. Only two groups are used instead of three groups, because the attribute date of birth has not been used as seed or first ordered attribute for creating a group of attributes a shown in FIG. 5A.

In the example of FIG. 5D, the method finds name blocks on L1 504A and L2 505C have reached their maximum capacity but L3 block 506B is still not filled, and all that results into 1000+1000+50=2050 candidate records. Similar to the example of FIG. 5C, the address blocks also suggest 700 candidates, which makes a total number of candidates based on the unique candidates across these two sets of 2050 and 700 candidates.

FIG. 6 depicts an example hardware implementation of data integration system 101. FIG. 6 represents a general computerized system, suited for implementing method steps as involved in the present disclosure.

It will be appreciated that the methods described herein are at least partly non-interactive, and automated by way of computerized systems, such as servers or embedded systems. In exemplary embodiments though, the methods described herein can be implemented in a (partly) interactive system. These methods can further be implemented in software, 622 (including firmware 622), hardware (processor) 605, or a combination thereof. In exemplary embodiments, the methods described herein are implemented in software, as an executable program, and is executed by a special or general-purpose digital computer, such as a personal computer, workstation, minicomputer, or mainframe computer. The most general system 101 therefore includes a general-purpose computer 601.

In exemplary embodiments, in terms of hardware architecture, as shown in FIG. 6, the computer 601 includes a processor 605, memory (main memory)610 coupled to a memory controller 615, and one or more input and/or output (I/O) devices (or peripherals) 10, 645 that are communicatively coupled via a local input/output controller 635. The input/output controller 635 can be, but is not limited to, one or more buses or other wired or wireless connections, as is known in the art. The input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 645 may generally include any generalized cryptographic card or smart card known in the art.

The processor 605 is a hardware device for executing software, particularly that stored in memory 610. The processor 605 can be any custom made or commercially available processor, a central processing unit (CPU), an auxiliary processor among several processors associated with the computer 601, a semiconductor-based microprocessor (in the form of a microchip or chip set), a macroprocessor, or generally any device for executing software instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the memory 610 can have a distributed architecture, where various components are situated remote from one another, but can be accessed by the processor 605.

The software in memory 610 may include one or more separate programs, each of which comprises an ordered listing of executable instructions for implementing logical functions, notably functions involved in embodiments of this invention.

The software in memory 610 shall also typically include a suitable operating system (OS) 611. The OS 611 essentially controls the execution of other computer programs, such as the algorithm 120. The algorithm 120 may, for example, comprise a database management system or a Java application. The algorithm 120 may comprise components for performing at least part of the present method. The algorithm 120 may further comprise a component for performing standardization of data records e.g. before performing the matching. The standardization refers to a process of transforming data to a predefined data format. The data format may include a common data definition, format, representation and structure. The data that is to be transformed is the data that is not conform to the predefined data format. For example, the process of transforming the data may comprise processing the data to automatically transform the data where necessary to comply with those common representations that define the data format. This process of transforming data may include identifying and correcting invalid values, standardizing spelling formats and abbreviations, and validating the format and content of the data.

The methods described herein may be in the form of a source program, executable program (object code), script, or any other entity comprising a set of instructions to be performed. When a source program, then the program needs to be translated via a compiler, assembler, interpreter, or the like, which may or may not be included within the memory 610, so as to operate properly in connection with the OS 611. Furthermore, the methods can be written as an object oriented programming language, which has classes of data and methods, or a procedure programming language, which has routines, subroutines, and/or functions.

In exemplary embodiments, a conventional keyboard 650 and mouse 655 can be coupled to the input/output controller 635. Other output devices such as the I/O devices 645 may include input devices, for example but not limited to a printer, a scanner, microphone, and the like. Finally, the I/O devices 10, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 645 can be any generalized cryptographic card or smart card known in the art. The system 101 can further include a display controller 625 coupled to a display 630. In exemplary embodiments, the system 101 can further include a network interface for coupling to a network 666. The network 666 can be an IP-based network for communication between the computer 601 and any external server, client and the like via a broadband connection. The network 666 transmits and receives data between the computer 601 and external systems 30, which can be involved to perform part or all of the steps of the methods discussed herein. In exemplary embodiments, network 666 can be a managed IP network administered by a service provider. The network 666 may be implemented in a wireless fashion, e.g., using wireless protocols and technologies, such as WiFi, WiMax, etc. The network 666 can also be a packet-switched network such as a local area network, wide area network, metropolitan area network, Internet network, or other similar type of network environment. The network 666 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 601 is a PC, workstation, intelligent device or the like, the software in the memory 610 may further include a basic input output system (BIOS) 622. The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute software stored within the memory 610, to communicate data to and from the memory 610, and to generally control operations of the computer 601 pursuant to the software. The methods described herein and the OS 611, in whole or in part, but typically the latter, are read by the processor 605, possibly buffered within the processor 605, and then executed.

When the systems and methods described herein are implemented in software, as is shown in FIG. 6, the methods can be stored on any computer readable medium, such as storage 620, for use by or in connection with any computer related system or method. The storage 620 may comprise a disk storage such as HDD storage.

Various embodiments are specified in the following numbered clauses:

1. A method for storing a dataset in a database system, the dataset comprising records having values of multiple attributes, the method comprising:
a) determining an ordered set of attributes of the multiple attributes;
b) for each distinct value of the first ordered attribute of the set creating a first level data block; the first level data block being configured to comprise a maximum number of records;
c) storing data records of the dataset having a distinct value of the first ordered attribute in the respective created first level data block;
d) in case a data block has the maximum number of records,
   determining a level of the data block;
   determining a subset of attributes of the set, the subset of attributes comprising attributes having an order starting from the first order to a subsequent level of the determined level;
   for each distinct group of values of the subset of attributes creating a next level data block, the next level is subsequent to the determined level, the next level data block being configured to comprise the maximum number of records;
   storing data records of the dataset having a distinct group of values of the subset of attributes in the respective created next level data block;
e) repeating step d) for each created data block, resulting in a group of blocks associated with the first ordered attribute.

2. The method of clause 1, further comprising repeating steps a) to e) for one more different further ordered sets of attributes of the multiple attributes, resulting in different groups of blocks associated with the first ordered attribute of the respective ordered set of attributes.

3. The method of clause 2, wherein the different ordered sets of attributes are not overlapping.

4. The method of clause 1, further comprising
receiving a record having at least a non-empty value of the first ordered attribute of the set of attributes;
determining in the group of blocks all applicable blocks that have the maximum number of records and an additional block that has less than the maximum number of records and that has a level that is equal or subsequent to the highest level of the determined all blocks;
comparing the received record with each record of the determined blocks.

5. The method of clause 1, wherein the distinct group of values comprises an empty value of an attribute that is different from the first ordered attribute.

6. The method of clause 2, further comprising
receiving a record having at least one non-empty value of an attribute of the multiple attributes;
identifying one or more groups of blocks that are associated with the at least one non-empty attribute;
for each of group of the one or more groups:
determining in the group of blocks all applicable blocks that have the maximum number of records and an additional applicable block that has less than the maximum number of records and that has a level that is equal or subsequent to the highest level of the determined all blocks;
comparing the received record with each record of the determined blocks.

7. The method of clause 2, the additional block being further associated with an attribute of the subset of attributes that has an empty value.

8. The method of clause 2, wherein comparing the received record comprises loading into a memory the identified groups of blocks for performing the comparison in the memory.

9. The method of clause 8, wherein the maximum number of records is determined based on the size of the memory.

10. The method of clause 2, further comprising deduplication of the data based on the comparison result.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for storing a dataset in a database system, the dataset comprising records having values of multiple attributes, the method comprising:
determining an ordered set of attributes of the multiple attributes;
for each distinct value of the first ordered attribute of the set, creating a first level data block, the first level data block being configured to comprise a maximum number of records;
storing data records of the dataset having a distinct value of the first ordered attribute in the respective created first level data block;
in response to a data block having the maximum number of records:
determining a level of the data block;
determining a subset of attributes of the set, the subset of attributes comprising attributes having an order starting from the first order to a subsequent level of the determined level;
for each distinct group of values of the subset of attributes, creating a next level data block, the next level being subsequent to the determined level, the next level data block being configured to comprise the maximum number of records; and
storing data records of the dataset having a distinct group of values of the subset of attributes in the respective created next level data block; and
for each created data block, repeating determining the level of the data block, determining a subset of attributes of the set, and for each distinct group of values of the subset of attributes creating a next level data block, resulting in a group of blocks associated with the first ordered attribute.

2. The method of claim 1, further comprising repeating the method for one more different further ordered sets of attributes of the multiple attributes, resulting in different groups of blocks associated with the first ordered attribute of the respective ordered set of attributes.

3. The method of claim 2, wherein the different ordered sets of attributes are not overlapping.

4. The method of claim 1, further comprising:
receiving a record having at least a non-empty value of the first ordered attribute of the set of attributes;
determining from the group of blocks all applicable full blocks that have the maximum number of records and an additional applicable block that has less than the maximum number of records and that has a level that is equal or subsequent to the highest level of the determined full blocks; and
comparing the received record with each record of the determined blocks.

5. The method of claim 1, wherein the distinct group of values comprises an empty value of an attribute that is different from the first ordered attribute.

6. The method of claim 2, further comprising:
receiving a record having at least one non-empty value of an attribute of the multiple attributes;
identifying one or more groups of blocks that are associated with the at least one non-empty attribute;
for each group of the one or more groups:
determining from the group of blocks all applicable full blocks that have the maximum number of records and an additional applicable block that has less than the maximum number of records and that has a level that is equal or subsequent to the highest level of the full blocks; and
comparing the received record with each record of the determined blocks.

7. The method of claim 4, the additional block being further associated with an attribute of the subset of attributes that has an empty value.

8. The method of claim 4, wherein comparing the received record comprises loading into a memory the identified groups of blocks for performing the comparison in the memory.

9. The method of claim 8, wherein the maximum number of records is determined based on the size of the memory.

10. The method of claim 4, further comprising deduplicating the data based on the comparison result.

11. A computer program product for storing a dataset in a database system, the dataset comprising records having values of multiple attributes, the computer program product comprising one or more computer readable storage media and machine executable instructions stored on at least one of the computer readable storage media, wherein execution of the machine executable instructions causes a processor to perform a method comprising:
determining an ordered set of attributes of the multiple attributes;
for each distinct value of the first ordered attribute of the set, creating a first level data block, the first level data block being configured to comprise a maximum number of records;
storing data records of the dataset having a distinct value of the first ordered attribute in the respective created first level data block;
in response to a data block having the maximum number of records,
determining a level of the data block;
determining a subset of attributes of the set, the subset of attributes comprising attributes having an order starting from the first order to a subsequent level of the determined level;
for each distinct group of values of the subset of attributes, creating a next level data block, the next level being subsequent to the determined level, the next level data block being configured to comprise the maximum number of records; and
storing data records of the dataset having a distinct group of values of the subset of attributes in the respective created next level data block; and
for each created data block, repeating determining the level of the data block, determining a subset of attributes of the set, and for each distinct group of values of the subset of attributes creating a next level data block, resulting in a group of blocks associated with the first ordered attribute.

12. The computer program product of claim 11, wherein the method further comprises repeating the method for one more different further ordered sets of attributes of the multiple attributes, resulting in different groups of blocks associated with the first ordered attribute of the respective ordered set of attributes.

13. The computer program product of claim 12, wherein the different ordered sets of attributes are not overlapping.

14. The computer program product of claim 11, wherein the method further comprises:
receiving a record having at least a non-empty value of the first ordered attribute of the set of attributes;
determining from the group of blocks all applicable full blocks that have the maximum number of records and an additional applicable block that has less than the maximum number of records and that has a level that is equal or subsequent to the highest level of the determined full blocks; and
comparing the received record with each record of the determined blocks.

15. The computer program product of claim 11, wherein the distinct group of values comprises an empty value of an attribute that is different from the first ordered attribute.

16. The computer program product of claim 12, wherein the method further comprises:
receiving a record having at least one non-empty value of an attribute of the multiple attributes;
identifying one or more groups of blocks that are associated with the at least one non-empty attribute;
for each group of the one or more groups:
determining from the group of blocks all applicable full blocks that have the maximum number of records and an additional applicable block that has less than the maximum number of records and that has a level that is equal or subsequent to the highest level of the full blocks; and
comparing the received record with each record of the determined blocks.

17. The computer program product of claim 14, the additional block being further associated with an attribute of the subset of attributes that has an empty value.

18. The computer program product of claim 14, wherein comparing the received record comprises loading into a memory the identified groups of blocks for performing the comparison in the memory.

19. The computer program product of claim 18, wherein the maximum number of records is determined based on the size of the memory.

20. A computer system for storing a dataset in a database system, the dataset comprising records having values of multiple attributes, the computer system being configured to:
determine an ordered set of attributes of the multiple attributes;
for each distinct value of the first ordered attribute of the set, create a first level data block, the first level data block being configured to comprise a maximum number of records;
store data records of the dataset having a distinct value of the first ordered attribute in the respective created first level data block;
in response to a data block having the maximum number of records,
determine a level of the data block;
determine a subset of attributes of the set, the subset of attributes comprising attributes having an order starting from the first order to a subsequent level of the determined level;
for each distinct group of values of the subset of attributes, create a next level data block, the next level being subsequent to the determined level, the next level data block being configured to comprise the maximum number of records; and
store data records of the dataset having a distinct group of values in the respective created next level data block; and
for each created data block, repeat determining the level of the data block, determining a subset of attributes of the set, and for each distinct group of values of the subset of attributes creating a next level data block, resulting in a group of blocks associated with the first ordered attribute.
